(19) United States
(12) Patent Application Publication
(10) Pub. No.: US 2026/0129057 A1
(43) Pub. Date: May 7, 2026

(54) METHODS AND APPARATUS TO DYNAMICALLY UPDATE A THREAT LIST

(71) Applicant: Musarubra US LLC, San Jose, CA (US)

(72) Inventor: Daksh Kapur, New Delhi (IN)

(21) Appl. No.: 18/939,086

(22) Filed: Nov. 6, 2024

(51) Int. Cl. H04L 9/40

(52) U.S. Cl. CPC H04L 63/1416

(57) ABSTRACT

Systems, apparatus, articles of manufacture, and methods are disclosed. An example apparatus includes interface circuitry, machine readable instructions, and programmable circuitry to at least one of instantiate or execute the machine readable instructions to: analyze detection data from an unknown source to identify a potential threat, add an entry to a security event cache that describes the potential threat, determine a number of entries in the security event cache that correspond to the unknown source, in response to a determination that the number of entries exceeds a threshold, add the unknown source to a threat list, and perform, in response to the addition of the unknown source to the threat list, a responsive action corresponding to the unknown source.

### FIELD OF THE DISCLOSURE

This disclosure relates generally to cybersecurity and, more particularly, to methods and apparatus to dynamically update a threat list.

### BACKGROUND

Malicious software, known as “malware,” can attack various computing devices via a network, such as the Internet. Malware may include any program or file that is intentionally harmful to a computer, such as computer virus programs, Internet bots, spyware, computer worms and other standalone malware computer programs that replicate to spread to other computers, Trojan horse and other non-replicating malware, or any computer program that gathers information about a computer, its user, or otherwise operates without permission. Protecting computing devices from such malware can be a significant challenge.

### BRIEF DESCRIPTION OF THE DRAWINGS

FIG. 1 is a block diagram of an example environment in which cybersecurity operations are performed.

FIG. 2 is a block diagram of an example implementation of the tracker circuitry of FIG. 1.

FIG. 3 is a block diagram of an example implementation of the threat manager circuitry of FIG. 1.

FIG. 4A-4E are illustrative examples of use cases that implement the threat tracker circuitry and threat manager circuitry of FIG. 1.

FIG. 5 is a flowchart representative of example machine readable instructions and/or example operations that may be executed, instantiated, and/or performed by example programmable circuitry to implement the threat tracker circuitry of FIG. 1.

FIG. 6 is a flowchart representative of example machine readable instructions and/or example operations that may be executed, instantiated, and/or performed by example programmable circuitry to implement the threat manager circuitry of FIG. 1.

FIG. 7 is a flowchart representative of example machine readable instructions and/or example operations that may be executed, instantiated, and/or performed by example programmable circuitry to conditionally remove a source from a threat list as described in FIG. 6.

FIG. 8 is a block diagram of an example processing platform including programmable circuitry structured to execute, instantiate, and/or perform the example machine readable instructions and/or perform the example operations of FIGS. 5, 6, and/or 7 to implement one or more devices in the environment of FIG. 1.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 5, 6, and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

A variety of techniques can be employed to protect computing devices against malware. In one technique, a system assigns reputation values to unknown sources that generate data, where actions that indicate the source is safe increase the reputation value and actions that indicate the source is malicious decrease the reputation value. If the reputation value of a particular data source becomes sufficiently low, the system adds the data source to a threat list and blocks future transmissions form the data source.

The types of malware attacks employed against a target, the effectiveness of an attack, and the source(s) of an attack can change quickly. As a result, systems that use reputation values to update a threat list can struggle to effectively adapt to changes to the security landscape. For example, such systems are generally slow to update reputation values because the consequences of being added to the threat list are significant (e.g., having all future communication from the sources on the threat list blocked). Accordingly, a malicious actor could exploit a reputation-based threat list system by sending different amounts of malicious data from different sources. Without any information that indicates the malicious actor is sending data through multiple sources, the system may assign one reputation value per source and evaluate the reputation values independently. If the amount of data sent through any one source is not enough to decrease the source's reputation value, the system would not add the source to the threat list. Yet the cumulative amount of data sent by the malicious actor across multiple sources can have significant adverse effects on the target. More generally, delayed updates suffered by reputation-based threat lists pose security risks and decrease the effectiveness of the malware protection system.

Example methods, apparatus, and systems described herein implement a dynamic threat list. Example threat tracker circuitry analyzes incoming detection data to populate a security event cache. The security event cache stores data that describes potential threats. If a threshold number of entries in the security event cache correspond to a single source, and/or if the source passes one or more entrance conditions, the threat tracker circuitry adds the source to a threat list. Once a source is on the threat list, example threat manager circuitry takes preventative actions to mitigate malicious activity. The threat manager circuitry removes the source from the threat list after the source has been on the threat list for a threshold amount of time and/or if the source passes one or more exit conditions.

Example methods, apparatus, and systems described herein implement one or more of the foregoing operations in substantially real time. As used herein “substantially real time” refers to occurrence in a near instantaneous manner recognizing there may be real world delays for computing time, transmission, etc. Thus, unless otherwise specified, “substantially real time” refers to real time +1 second. Accordingly, the example threat lists described herein update quicker than reputation based threat lists. Furthermore, threat lists described in examples disclosed herein can add sources to the threat list more aggressively than reputation based threat lists because the customizable expiration of sources on the threat list protects against false positives. Accordingly, malware systems that employ a threat list described herein are less susceptible to security risks than malware systems that employ a reputation-based threat list.

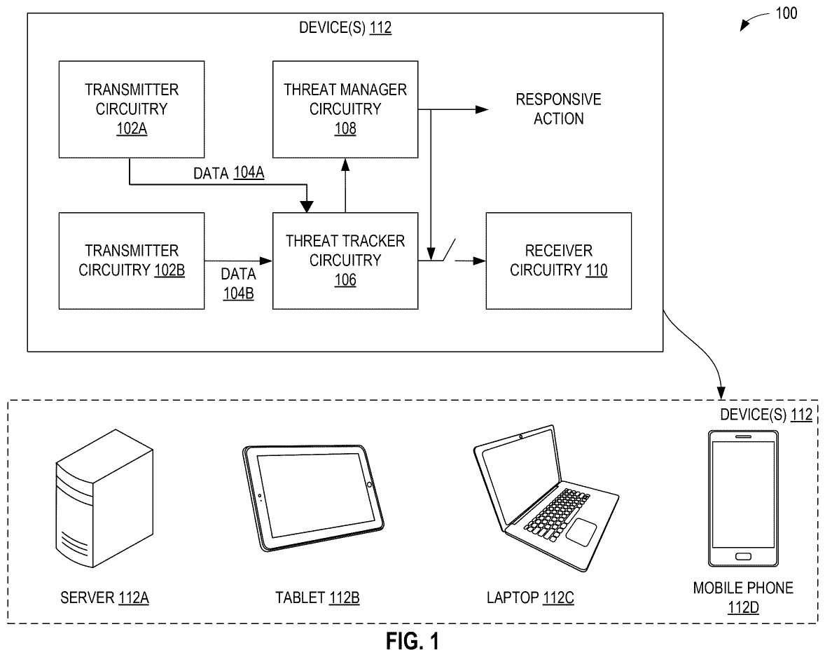

FIG. 1 is a block diagram of an example environment 100 in which cybersecurity operations are performed. The example of FIG. 1 shows the environment 100 includes device(s) 112. The device(s) 112 include transmitter circuitry 102A and 102B (collectively referred to as transmitter circuits 102), data 104A and 104B (collectively referred to as data 104), threat tracker circuitry 106, threat manager circuitry 108, and receiver circuitry 110. The device(s) 112 are implemented by one or more of a server device 112A, a tablet 112B, a laptop 112C, and a mobile phone 112D.

The transmitter circuits 102 refer to components that attempt to transmit the data 104 to the receiver circuitry 110. Accordingly, the receiver circuitry 110 refers to a component that uses the data 104 transmitted by the transmitter circuits 102 to perform one or more tasks. In some examples, the receiver circuitry 110 is referred to as a data consumer.

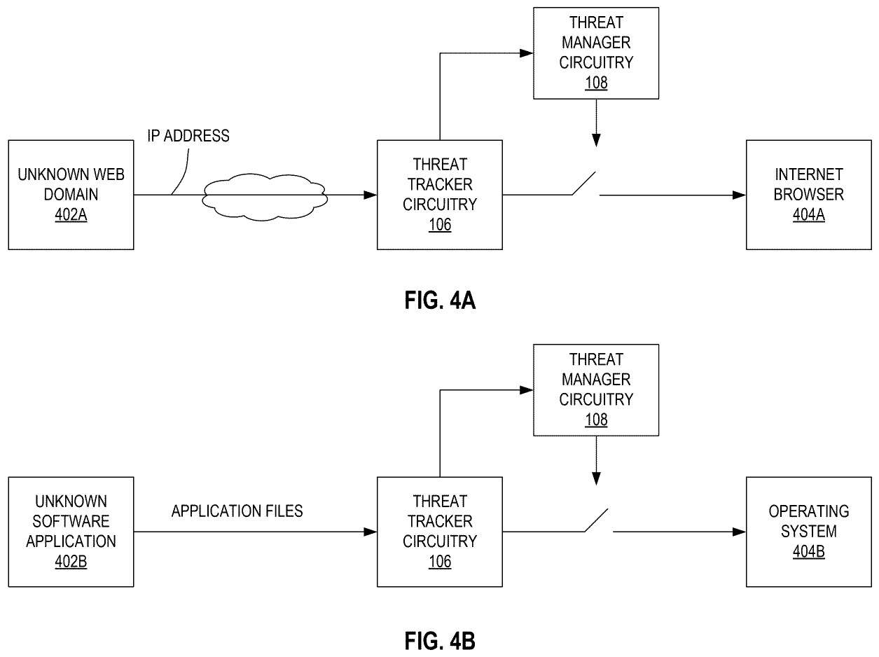

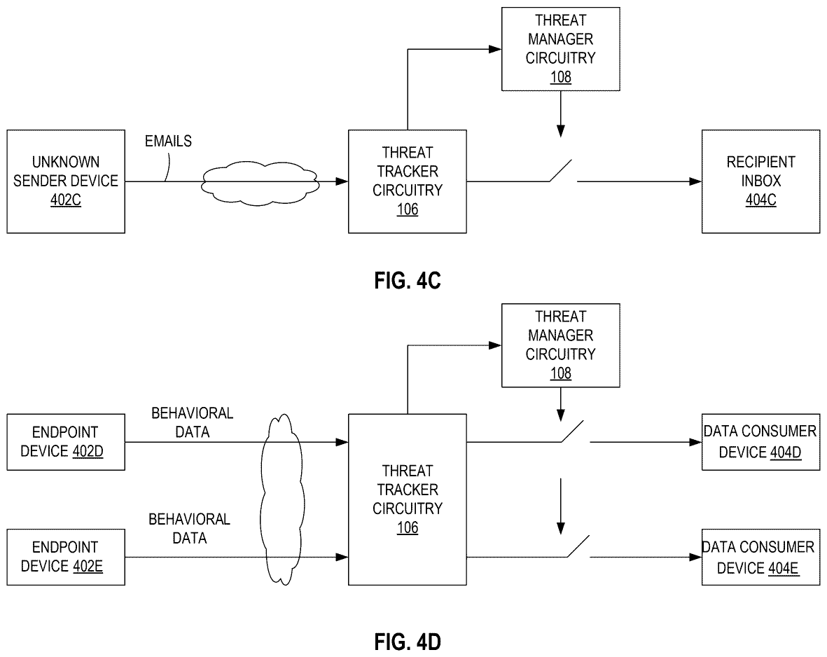

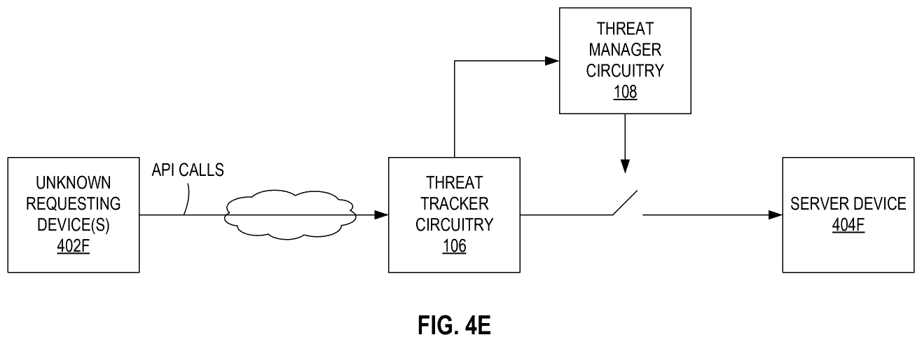

The transmitter circuitry 102 may attempt to transmit any amount and any type of data 104 to the receiver circuitry 110. Similarly, the receiver circuitry 110 may perform any number and any type of tasks using the data 104. In general, the amount of data, type of data, and type of operations performed in examples described herein change based on the application-specific context of the environment 100 in which the device(s) 112 is/are implemented. Examples of application-specific data and operations are described further in connection with FIG. 4A-4E.

While the example of FIG. 1 shows two transmitter circuits 102A and 102B, any number of transmitter circuits 102 may attempt to transmit data to the receiver circuitry 110. In some examples, the transmitter circuitry 102 is referred to as a source of data. In some examples, the transmitter circuitry 102A and 102B are controlled by the same actor as described above. In other examples, the transmitter circuitry 102A and 102B operate independently of one another.

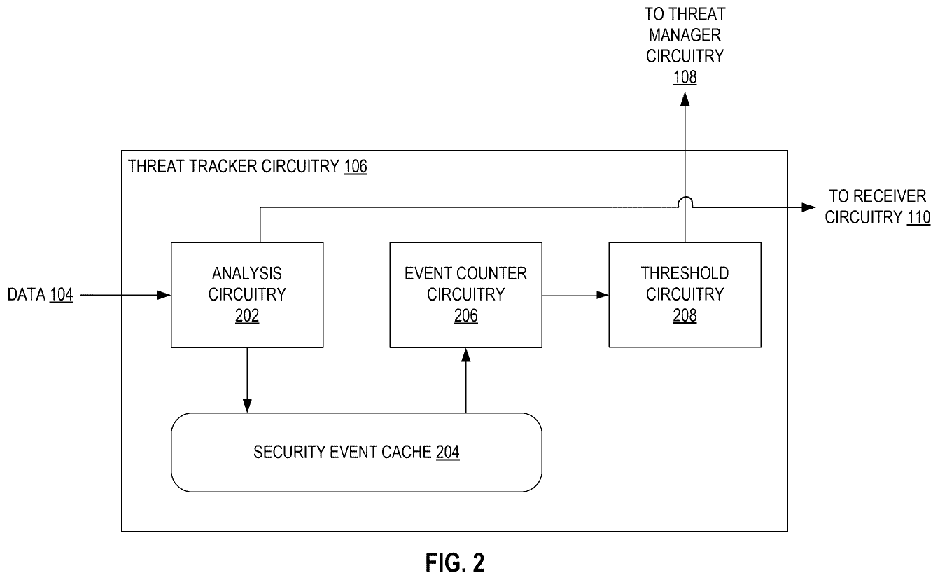

The receiver circuitry 110 is implemented independently from the transmitter circuits 102. The receiver circuitry 110 therefore risks falling prey to a malware attack from one or both of the transmitter circuits 102A and 102B if the receiver circuitry 110 blindly trusts the transmitter circuits 102. Instead, the threat tracker circuitry 106 intercepts the data 104 from the transmitter circuits 102 before it reaches the receiver circuitry 110. The threat tracker circuitry 106 analyzes the data 104A and the data 104B independently from one another to determine whether to trust the transmitter circuitry 102A and the transmitter circuitry 102B, respectively. If the threat tracker circuitry 106 determines a given transmitter circuit 102A can be trusted, the threat tracker circuitry 106 forwards the corresponding data 104A to the receiver circuitry 110. Alternatively, the threat tracker circuitry 106 alerts the threat manager circuitry 108 in response to a determination that a given transmitter circuit 102B cannot be trusted. The threat tracker circuitry 106 is described further in connection with FIG. 2.

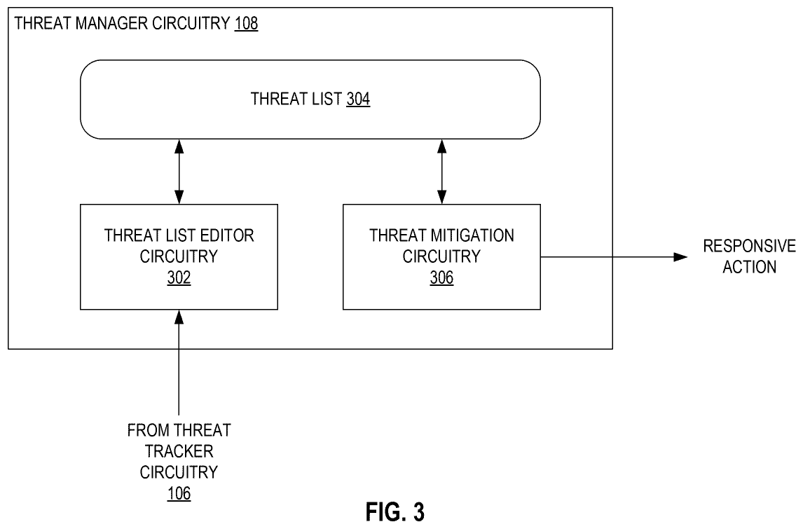

The threat manager circuitry 108 maintains a threat list that represents a list of sources that are currently identified as malicious. The threat manager circuitry 108 adds a source to the threat list in response to being notified of the source by the threat tracker circuitry 106. The threat list is described further in connection with FIG. 3.

The threat manager circuitry 108 performs responsive actions towards sources that are on the threat list. For example, the threat manager circuitry 108 may prevent the receiver circuitry 110 from obtaining the data 104B (represented in the example of FIG. 1 as opening a switch) if the transmitter circuitry 102B is on the threat list. Responsive actions are described further in connection with FIG. 3.

The threat manager circuitry 108 also removes sources from the threat list. The threat manager circuitry 108 removes sources from the threat list based on the passage of a threshold amount of time and/or the source passing one or more logical exit conditions. The threat manager circuitry 108 is described further in connection with FIG. 3.

The environment 100 shows that any number of the transmitter circuits 102, the threat tracker circuitry 106, the threat manager circuitry 108, and the receiver circuitry 110 may be implemented within any number of the device(s) 112. Thus, in some examples, the transmitter circuits 102 and the receiver circuitry 110 are implemented on the same device. In other examples, the source of the data 104 is a device that is implemented remotely from the receiver circuitry 110. Similarly, in some examples, the threat tracker circuitry 106 and the threat manager circuitry 108 are implemented locally on the same device as the receiver circuitry 110. In other examples, the receiver circuitry 110 is implemented on a client-facing device (e.g., the tablet 112B, laptop 112C, mobile phone 112D, etc.) while the threat tracker circuitry 106 and the threat manager circuitry 108 are implemented on one or more remote devices (e.g., the server 112A).

One or more communications between the transmitter circuits 102, the threat tracker circuitry 106, the threat manager circuitry 108, and/or the receiver circuitry 110 may occur using hardware connections including but not limited to wires, interconnects, etc. In some examples, communication between the transmitter circuits 102, the threat tracker circuitry 106, the threat manager circuitry 108, and/or the receiver circuitry 110 occurs over a network. In some of network examples, the network is the Internet. However, the example network may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events. Additionally or alternatively, the components of FIG. 1 communicate with one another using a different protocol including but not limited to Bluetooth, Near Field Communication (NFC), etc.

The transmitter circuits 102, the threat tracker circuitry 106, the threat manager circuitry 108, and/or the receiver circuitry 110 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the transmitter circuits 102, the threat tracker circuitry 106, the threat manager circuitry 108, and/or the receiver circuitry 110 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

FIG. 2 is a block diagram of an example implementation of the threat tracker circuitry 106 of FIG. 1. In the illustrated example of FIG. 2, the threat tracker circuitry 106 includes analysis circuitry 202, a security event cache 204, event counter circuitry 206, and threshold circuitry 208.

The analysis circuitry 202 obtains the data 104 from the transmitter circuits 102. In general, the data 104 can be implemented by any number of individual transmissions from the transmitter circuits 102 that are sent at any time and contain any amount of data. The analysis circuitry 202 analyzes transmissions within the stream of data 104 to identify data transmissions that are indicative of malicious activity. In some examples, a data transmission that is indicative of malicious activity is referred to as a security event.

The analysis circuitry 202 may use any suitable techniques to determine whether to label a data transmission as a security event. Such techniques include but are not limited to signature based detection, statically reviewing metadata, performing operations with the data in a sandbox environment, etc. In some examples, the analysis circuitry 202 executes a machine learning model to identify and label specific data transmissions as security events. In some examples, a data transmission labeled as a security event may also be referred to as a potential threat.

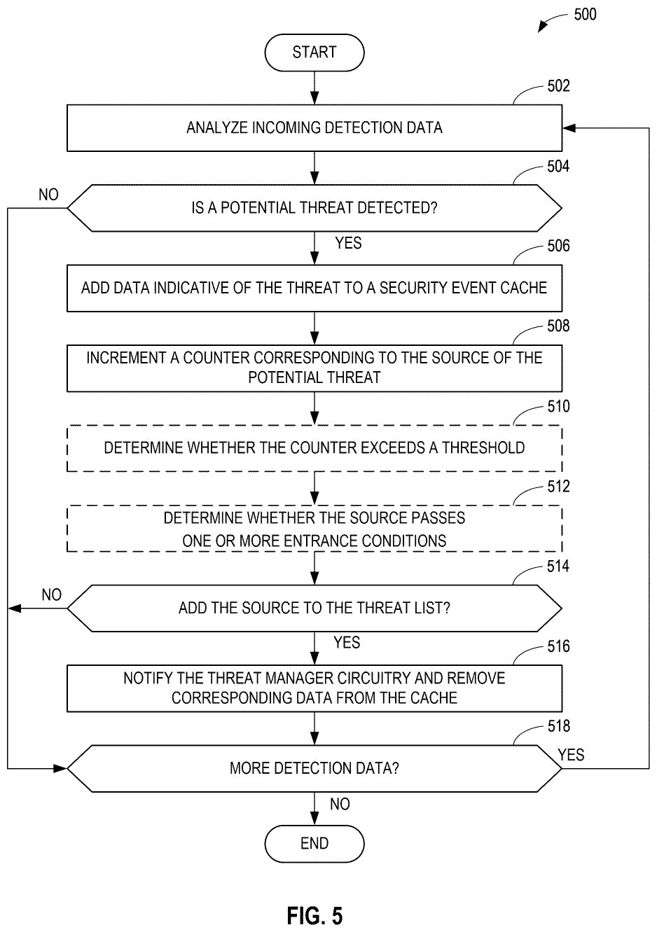

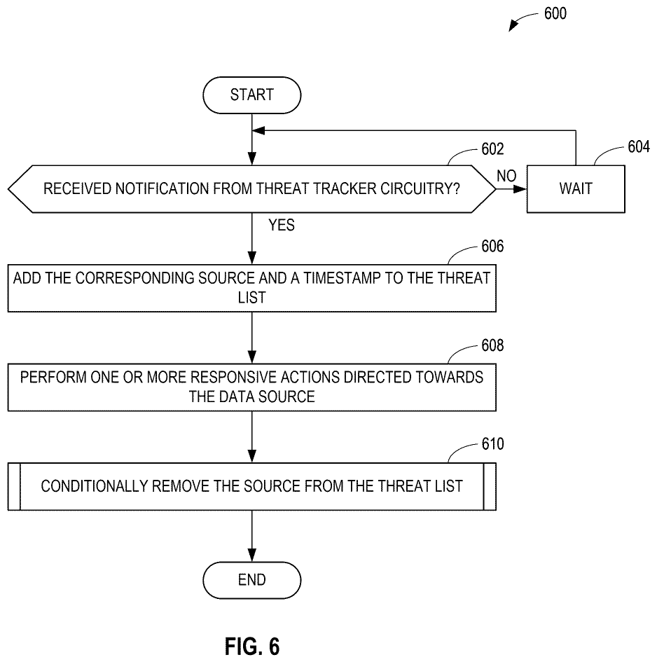

The techniques used by the analysis circuitry 202 may be developed by the same entity as the threat manager circuitry 108 or may be implemented as an independent, third-party system. The analysis circuitry 202 enters data descriptive of the security event into the security event cache 204. In some examples, the analysis circuitry 202 is instantiated by programmable circuitry executing analysis instructions and/or configured to perform operations such as those represented by the flowchart(s) of FIGS. 5, 6, and/or 7.

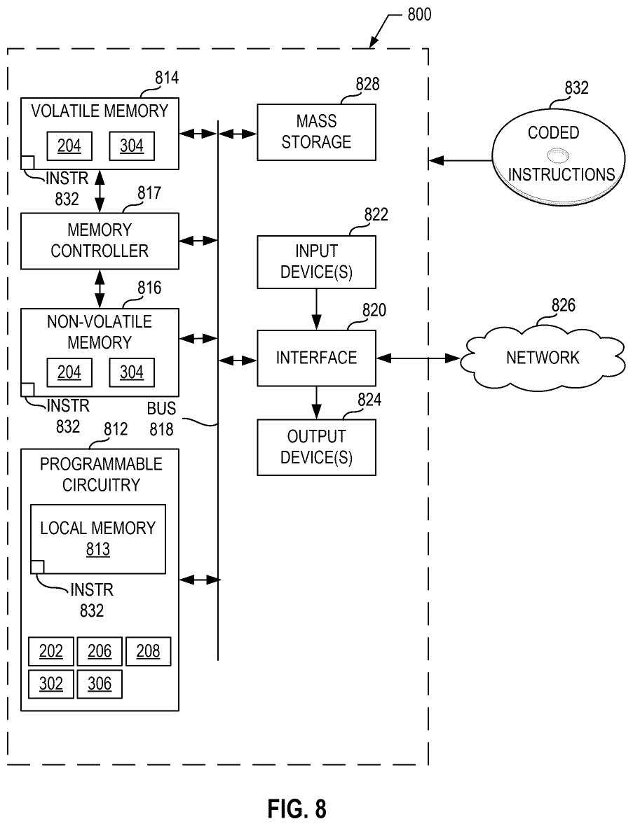

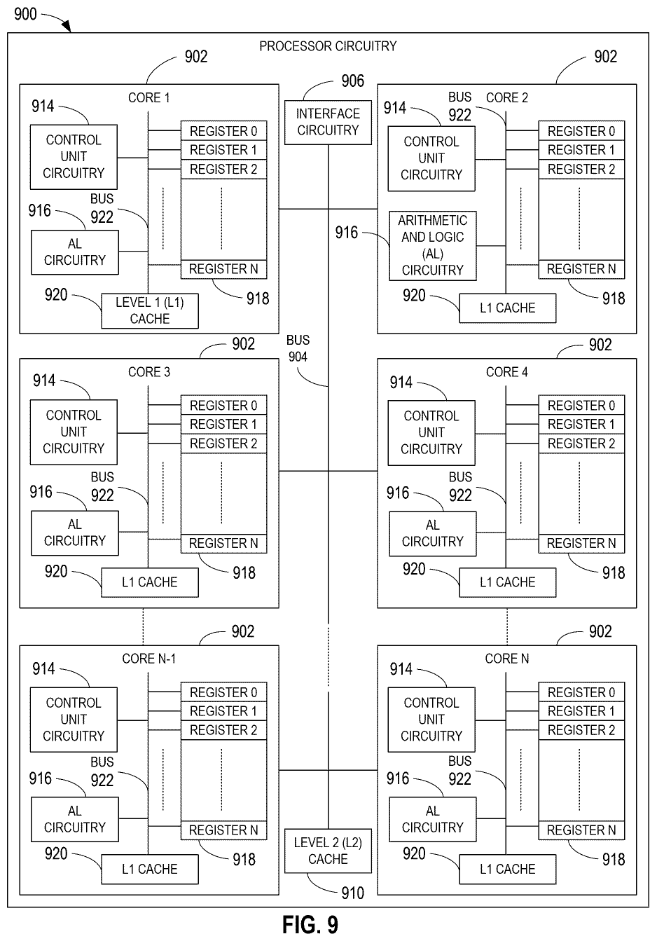

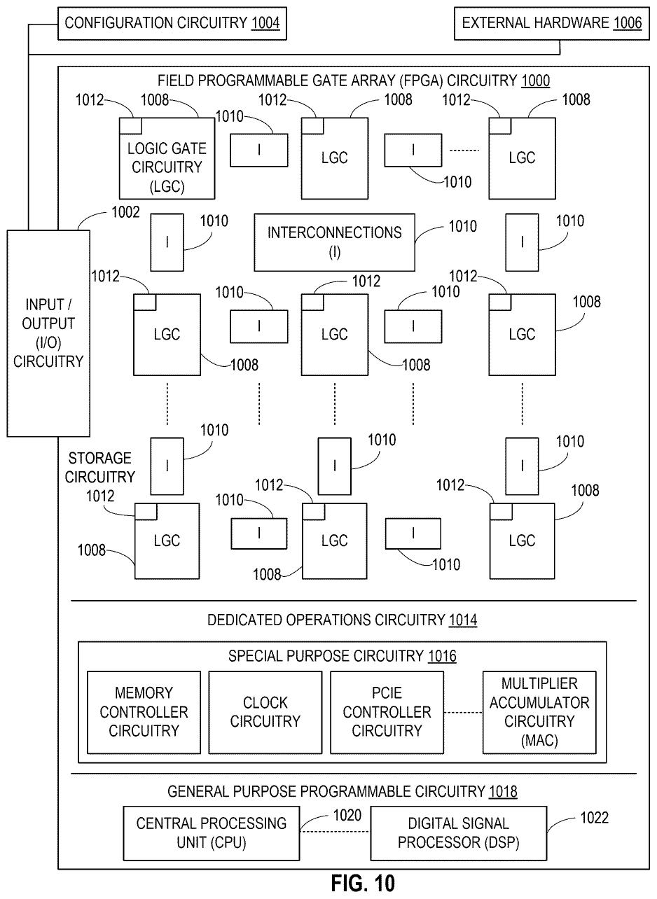

In some examples, the threat tracker circuitry 106 includes means for identifying potential threats amongst data. For example, the means for identifying may be implemented by analysis circuitry 202. In some examples, the analysis circuitry 202 may be instantiated by programmable circuitry such as the example programmable circuitry 812 of FIG. 8. For instance, the analysis circuitry 202 may be instantiated by the example microprocessor 900 of FIG. 9 executing machine executable instructions such as those implemented by at least blocks 502, 504 of FIG. 5. In some examples, the analysis circuitry 202 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the analysis circuitry 202 may be instantiated by any other combination of hardware, software, and/or firmware. For example, the analysis circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security event cache 204 refers to an amount of memory that stores security event entries. A given entry in the security event cache 204 refers to an individual instance in which the analysis circuitry 202 determined a data transmission is indicative of malicious activity. Accordingly, a given entry in the security event cache 204 includes a description of the source of the data transmission and a timestamp that represents when the analysis circuitry 202 received the data. In some examples, entries in the security event cache 204 include additional fields including but not limited to: a description of the type of the data and/or the underlying content, a copy of some or all of the data, a description of the intended recipient of the data (if the threat tracker circuitry 106 protects multiple receiver circuitry 110 instances), etc.

The security event cache 204 may be implemented as any type of memory. For example, the security event cache 204 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

The event counter circuitry 206 counts the number of entries in the security event cache 204 that corresponds to a single source. In this example, the event counter circuitry 206 manages one counter value per unique source in the security event cache 204. Thus, if portions of the data 104A and the data 104B both enter the security event cache 204, the event counter circuitry 206 manages a first counter representing the number of data transmissions from the transmitter circuitry 102A that are labeled security events and manages a second, separate counter representing the number of data transmissions from the transmitter circuitry 102B that are labeled security events. In some examples, the event counter circuitry 206 is instantiated by programmable circuitry executing event counter instructions and/or configured to perform operations such as those represented by the flowchart(s) of FIGS. 5, 6, and/or 7.

In some examples, the threat tracker circuitry 106 includes means for determining a number of entries in the security event cache 204 that correspond to a source. For example, the means for determining a number of entries may be implemented by event counter circuitry 206. In some examples, the event counter circuitry 206 may be instantiated by programmable circuitry such as the example programmable circuitry 812 of FIG. 8. For instance, the event counter circuitry 206 may be instantiated by the example microprocessor 900 of FIG. 9 executing machine executable instructions such as those implemented by at least blocks 508 of FIG. 5. In some examples, the event counter circuitry 206 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the event counter circuitry 206 may be instantiated by any other combination of hardware, software, and/or firmware. For example, the event counter circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The threshold circuitry 208 notifies the threat manager circuitry 108 of sources that represent enough security risk to justify their addition to a threat list. The threshold circuitry 208 may use a number of tests to determine when to notify the threat manager circuitry 108 about a given source. In a first test, the threshold circuitry 208 receives the count values from the event counter circuitry 206 and compares a given count value to a corresponding threshold value. In this example, the first test is satisfied when a count value is greater or equal to its corresponding threshold value.

The threshold circuitry 208 can also evaluate one or more entrance conditions as additional test when determining whether to add a particular source to the threat list. As used above and herein, an entrance condition refers to a logical condition that: a) uses information about a particular source as an input and b) resolves to a binary state (e.g., true or false, satisfied or not satisfied, etc.) when evaluated. An entrance condition is not limited to information that corresponds to an entrance condition, but instead may use any information available to the threat tracker circuitry 106, the threat manager circuitry 108, and/or the receiver circuitry 110 as inputs.

Entrance conditions can include a wide variety of decisions. In a first example, the threshold circuitry 208 evaluates a first entrance condition related to the frequency of interactions (e.g., by determining whether the difference between the oldest timestamp corresponding to a source and the earliest timestamp corresponding to the same source is less than a threshold value). In a second example, the threshold circuitry 208 evaluates a second entrance condition by determining whether a data transmission corresponding to the source is missing or has invalid authentication, attestation, or encryption data. In a third example, the threshold circuitry 208 evaluates a third entrance condition by determining whether a data transmission deviates from an established baseline activity. In a fourth example, the threshold circuitry 208 evaluates a fourth entrance condition by determining whether the threat tracker circuitry 106 has received direct feedback from users that correspond to a particular data transmission (e.g., an email is marked as phishing). In a fifth example, the threshold circuitry 208 evaluates a fifth entrance condition by determining whether the one or more data transmissions meet industry-developed criteria for an Indicator of Compromise (IOC). In a sixth example, the threshold circuitry 208 evaluates a sixth entrance condition by determining whether one or more data transmissions have violated a security policy. In other examples, the threshold circuitry 208 evaluates different entrance conditions.

The threshold circuitry 208 can implement different threshold values, different entrance conditions, and/or different parameters for entrance conditions depending on specific properties of the source being evaluated. For example, the threshold circuitry 208 may apply a first entrance condition for a security event that represents an email but apply a different, second entrance condition for a security event that represents executable (.exe) files. As another example, the threshold circuitry 208 may apply a higher threshold value to a source that was previously identified as safe than to a source that has not been previously analyzed.

The threshold circuitry 208 may evaluate any number of tests in any combination and in any order. Thus, the threshold circuitry 208 may compare the count value to the threshold value: a) before any entrance conditions are evaluated, b) only after a first number of conditions are satisfied but before a second number of entrance conditions, c) only after the entrance conditions have been satisfied, d) without performing any other tests for the current determination, etc. In some examples, the threshold circuitry 208 determines whether to add a source to a list by evaluating one or more entrance conditions but without comparing the count value to a threshold value.

The order of operations performed by the threshold circuitry 208 are adjustable because the threshold circuitry 208 may use AND logic to only add a source to the threat list if each of a specific set of tests are satisfied. In such examples, the threshold circuitry 208 can implement tests that are more likely to fail first to avoid wasting computational resources on a test that is ultimately not determinative of the outcome. Additionally or alternatively, the threshold circuitry 208 uses OR logic to add a source to the threat list if any of a specific set of tests are satisfied. In some examples, the threshold circuitry 208 uses a combination of both AND logic and OR logic to evaluate different sets of tests when determining whether to add a source to the threat list.

After notifying the threat manager circuitry 108 of a particular source, the threshold circuitry 208 removes data corresponding from the source from the security event cache 204 to prevent a single security event from being double counted as two separate reasons to add the source to the threat list. In some examples, the threshold circuitry 208 is instantiated by programmable circuitry executing threshold instructions and/or configured to perform operations such as those represented by the flowchart(s) of FIGS. 5, 6, and/or 7.

In some examples, the threat tracker circuitry 106 includes means for determining whether to add a data source to a threat list. For example, the means for determining whether to add a data source to a threat list may be implemented by threshold circuitry 208. In some examples, the threshold circuitry 208 may be instantiated by programmable circuitry such as the example programmable circuitry 812 of FIG. 8. For instance, the threshold circuitry 208 may be instantiated by the example microprocessor 900 of FIG. 9 executing machine executable instructions such as those implemented by at least blocks 510-516 of FIG. 5. In some examples, the threshold circuitry 208 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the threshold circuitry 208 may be instantiated by any other combination of hardware, software, and/or firmware. For example, the threshold circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Notably, a transmission that is added to the security event cache 204 does not by itself guarantee the source of the data transmission is malicious. Rather, the security event cache 204 stores any event that merely indicates or suggests that a data source may be malicious. Such broad categorization of data transmissions as security events, and the analysis circuitry 202 performing operations in substantially real time, allow the threshold circuitry 208 to add sources to a threat list more aggressively than reputation based threat lists. Thus, the threat tracker circuitry 106 can add malicious actors to a threat list more quickly than a reputation-based list can, thereby limiting the amount of damage the malicious actor can do while off the threat list. More generally, customizability in the threshold circuitry 208 described above allow a designer, manufacturer, or user of the threat tracker circuitry 106 to uniquely define when sources are added to the threat list in a manner that best fits the particular context.

FIG. 3 is a block diagram of an example implementation of the detector circuitry of FIG. 1. In the example of FIG. 3, the threat manager circuitry 108 includes threat list editor circuitry 302, a threat list 304, and threat mitigation circuitry 306.

The threat list editor circuitry 302 manages the contents of the threat list 304. For example, the threat list editor circuitry 302 adds sources and corresponding timestamps to the threat list 304 in response to a notification from the threat tracker circuitry 106 that identifies the source. In some examples, the threat list editor circuitry 302 adds additional information to the threat list 304 that corresponds to a source. Such additional information may include, but is not limited to: any of the information relating to the source that was stored in the security event cache 204, statistics describing the number of times and length of time the source has previously been on the threat list 304, etc. In some examples, the threat list editor circuitry 302 is instantiated by programmable circuitry executing threat list instructions and/or configured to perform operations such as those represented by the flowchart(s) of FIGS. 5, 6, and/or 7.

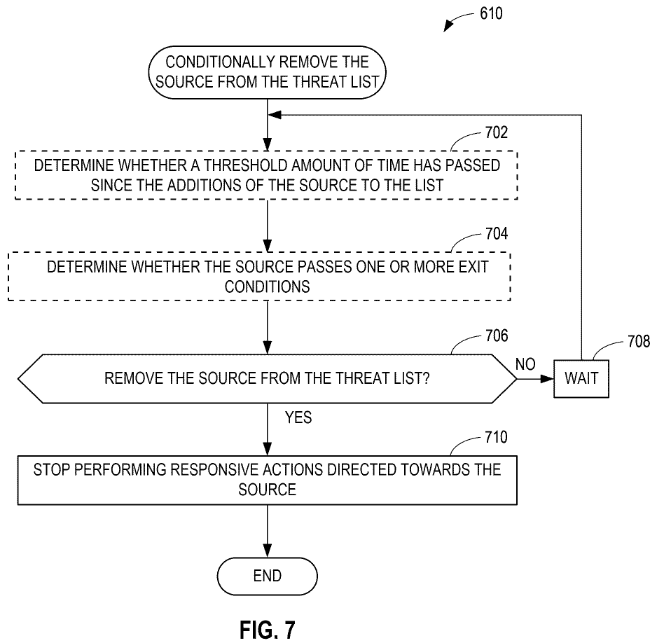

In some examples, the threat manager circuitry 108 includes means for adding or removing data sources from the threat list 304. For example, the means for adding or removing may be implemented by threat list editor circuitry 302. In some examples, the threat list editor circuitry 302 may be instantiated by programmable circuitry such as the example programmable circuitry 812 of FIG. 8. For instance, the threat list editor circuitry 302 may be instantiated by the example microprocessor 900 of FIG. 9 executing machine executable instructions such as those implemented by at least blocks 602, 608, 610, 702-710 of FIGS. 6 and 7. In some examples, the threat list editor circuitry 302 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the threat list editor circuitry 302 may be instantiated by any other combination of hardware, software, and/or firmware. For example, the threat list editor circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The threat list 304 refers to an amount of memory that identifies one or more data sources (e.g., the transmitter circuits 102). The threat list 304 may additionally include additional data that describes the identity or actions of the data source, as described above. The threat list 304 may be implemented by any type and any amount of memory.

A source is considered malicious (e.g., a threat) for the duration of the time it stays on the threat list 304. Accordingly, the threat mitigation circuitry 306 takes one or more responsive actions to the sources identified on the threat list 304. As used above and herein, a responsive action may refer to any operations that analyze previous security risks, reduce current security risks, or prevent future security risks caused by the source. In the examples of FIGS. 1 and 4A-4E, the responsive action is represented by the threat mitigation circuitry 306 opening a switch to prevent the data 104 that corresponds to the threat from reaching the receiver circuitry 110. Other responsive actions include but are not limited to notifying other internal modules or external modules of the threat, establishing filters to identify future data transmissions from the source, editing one or more portions of the existing data 104 to remove the malicious portion, editing an internal reputation rating of the data source, running advanced scans on artifacts related to the data source, reviewing previous data transmissions from the data source to identify additional malicious activity, conducting forensic analysis operations on any systems affected by the data transmission, etc. In some examples, the threat mitigation circuitry 306 is instantiated by programmable circuitry executing threat mitigation instructions and/or configured to perform operations such as those represented by the flowchart(s) of FIGS. 5, 6, and/or 7.

In some examples, the threat manager circuitry 108 includes means for performing a responsive action. For example, the means for performing a responsive action may be implemented by threat mitigation circuitry 306. In some examples, the threat mitigation circuitry 306 may be instantiated by programmable circuitry such as the example programmable circuitry 812 of FIG. 8. For instance, the threat mitigation circuitry 306 may be instantiated by the example microprocessor 900 of FIG. 9 executing machine executable instructions such as those implemented by at least blocks 608 of FIG. 6. In some examples, the threat mitigation circuitry 306 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the threat mitigation circuitry 306 may be instantiated by any other combination of hardware, software, and/or firmware. For example, the threat mitigation circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In addition to adding sources to the threat list 304, the threat list editor circuitry 302 also removes sources from the threat list 304. Similar to the threshold circuitry 208, the threat list editor circuitry 302 may use a number of tests to determine when to remove a source from the threat list 304. In a first test, the threat list editor circuitry 302 uses the timestamp data originally from the security event cache to determine the amount of time that has passed since the source was added to the threat list 304. In this example, the first test is satisfied when the amount of time the source has been on the threat list 304 is greater than a corresponding threshold value. A source that has been on the threat list 304 for more than a threshold amount of time may be referred to as expired.

The threat list editor circuitry 302 can also evaluate one or more exit conditions as additional tests when determining whether to remove a particular source from the threat list 304. As used above and herein, an exit condition refers to a logical condition that: a) uses information about a particular source as an input and b) resolves to a binary state (e.g., true or false, satisfied or not satisfied, etc.) when evaluated. Evaluation of an exit condition is not limited to information that corresponds to a source, but instead may use any information available to the threat tracker circuitry 106, the threat manager circuitry 108, and/or the receiver circuitry 110 as inputs.

Exit conditions may include a wide variety of decisions. In a first example, the threat list editor circuitry 302 evaluates a first exit condition by determining whether the source has attempted to send payload data while the source is on the threat list 304. In a second example, the threat list editor circuitry 302 evaluates a second exit condition by determining whether the threat tracker circuitry 106 has received corrected or previously missing authentication, attestation, or encryption data that corresponds to the source. Such corrected or previously missing data may be transmitted by the source on the threat list 304 or from an external device. In a third example, the threat list editor circuitry 302 evaluates a third exit condition by determining whether the data 104 corresponding to the source has passed one or more software tests. Such software tests may include but are not limited to unit tests, functional tests, end-to-end tests, etc. In a fourth example, the threat list editor circuitry 302 evaluates a fourth exit condition by reevaluating flagged behavior with additional data that has been received since a data source was added to the threat list 304. In such examples, the threat list editor circuitry 302 may use the additional data to determine whether previous anomalies still exist, or to determine whether previous anomalies were a false positive (which would indicate the data source is actually benign). In fifth example, the threat list editor circuitry 302 evaluates a fifth exit condition by determining whether the threat tracker has been manually overridden by a user expressly indicating that a data source on the threat list 304 is safe. In other examples, the threat list editor circuitry evaluates different exit conditions.

The threat list editor circuitry 302 can implement different threshold values for expiration, different exit conditions, and/or different parameters used to evaluate exit conditions depending on the specific properties of the source being evaluated. For example, the threat list editor circuitry 302 may apply a first exit condition for a security event that represents an email but apply a different, second exit condition for a security event that represents executable (.exe) files. As another example, the threat list editor circuitry 302 may apply a lower threshold value for expiration to a source that was previously identified as safe than to a source that has not been previously analyzed.

The threat list editor circuitry 302 may evaluate any number of tests in any combination and in any order. Thus, the threat list editor circuitry 302 may check if a particular source has expired: a) before any exit conditions are evaluated, b) only after a first number of exit conditions are satisfied but before a second number of exit conditions, c) only after the exit conditions have been satisfied, d) without performing any other tests for the current determination, etc. In some examples, the threat list editor circuitry 302 determines to remove a source from the threat list 304 by evaluating one or more exit conditions, but without checking to see if the source has expired.

The order of operations performed by the threat list editor circuitry 302 are adjustable because the threat list editor circuitry 302 may use AND logic to only remove a source from the threat list 304 if each test within a set of tests is satisfied. In such examples, the threat list editor circuitry 302 can implement tests that are more likely to fail first to avoid wasting computational resources on a test that is ultimately not determinative of the outcome. Additionally or alternatively, the threat list editor circuitry 302 uses OR logic to remove a source from the threat list 304 if any one test from a set of tests is satisfied. In some examples, the threat list editor circuitry 302 uses a combination of both AND logic and OR logic to evaluate different sets of tests when determining whether to remove a source from the threat list 304.

Notably, the threat manager circuitry 108 performs operations in substantially real-time. The threat manager circuitry 108 also performs operations continuously in parallel with operations performed by the threat tracker circuitry 106. Thus, the threat tracker circuitry 106 can remove sources from a threat list 304 faster than a reputation-based list can so that any false-positives (e.g., safe data sources that were incorrectly added to the threat list 304 by the threat tracker circuitry 106) can be quickly removed from the threat list 304 and free to transmit data 104 to the receiver circuitry 110.

Furthermore, examples described herein limit the risk presented by data sources that are actually malicious and inadvertently removed the threat list 304 by the threat list editor circuitry 302. The foregoing risk is limited because any further malicious activity by the data source can be quickly identified by the substantially real time and continuous operations of the threat tracker circuitry 106, thereby prompting the data source to be added back to the threat list 304. As an example, the threat tracker circuitry 106 and the threat manager circuitry 108 may adjust one or more parameters used in the entrance conditions and exit conditions, respectively, so that a data source that has been on the threat list 304 previously is more likely to be readmitted to the threat list 304 and less likely to be removed from the threat list 304 than a data source that has never been on the threat list 304. More generally, customizability in the threat list editor circuitry 302 described above allow a designer, manufacturer, or user of the threat manager circuitry 108 to uniquely define when sources are removed from the threat list in a manner that best fits the particular context.

FIG. 4A-4E are illustrative examples of use cases that implement the threat tracker circuitry 106 and threat manager circuitry 108 of FIG. 1. The examples of FIG. 4A-4E collectively include data sources 402A, 402B, . . . (collectively referred to as data sources 402), the threat tracker circuitry 106, the threat manager circuitry 108, and data consumers 404A, 404B, . . . (collectively referred to as data consumers 404). The data sources 402 are implemented by one or more of the transmitter circuits 102 described in the example of FIG. 1. Similarly, the data consumers 404 are implemented by one or more instances of the receiver circuitry 110 described in the example of FIG. 1. Like FIG. 1, responsive actions that include blocking data from recaching the data consumers 404 are represented in the examples of FIG. 4A-4E by the threat manager circuitry 108 opening a switch.

In the example of FIG. 4A, the data source 402A is an unknown web domain and the data consumer 404A is an internet browser that can display webpages. In such examples, the data source 402A uses a network to transmit both payload data that describes a webpage and an internet protocol (IP address) of the unknown web domain. Accordingly, the threat tracker circuitry 106 may track and analyze patterns of malicious activity associated with specific IP addresses or ranges. Similarly, the threat tracker circuitry 106 may track and analyze patterns of malicious activity associated with specific domain names. The threat tracker circuitry 106 can also apply behavioral analysis to network traffic to detect unusual patterns or high volumes of activity from particular sources. Such activity may indicate malicious activity including but not limited to a potential coordinated attack or compromise.

Regardless of which foregoing technique or combination of techniques is utilized by the threat tracker circuitry 106, the threat manager circuitry 108 takes responsive actions to the data source 402A once it is added to the threat list 304. In the example of FIG. 4A, the responsive actions include preventing the internet browser from contacting the unknown web domain or displaying the webpage.

In the example of FIG. 4B, the data source 402B is an unknown software application and the data consumer 404B is an operating system. The data transmitted by the software application includes or represents application files that, if accessed by the operating system, enable execution of the software application. Accordingly, the threat tracker circuitry 106 track the origins of files flagged as malicious. The threat tracker circuitry 106 may use any technique to identify the application files as malicious, including but not limited to a static analysis of the files, executing the file in a sandbox environment, etc. Regardless of the technique(s) utilized by the threat tracker circuitry 106, the threat manager circuitry 108 takes responsive actions to the data source 402B once it is added to the threat list 304. In the example of FIG. 4B, the responsive actions include containment, isolation, or remediation operations that make the application files inaccessible to the operating system.

In the example of FIG. 4C, the data source 402C is an unknown email sender and the data consumer 404C is a recipient inbox. In such examples, the data source 402C uses a network to transmit emails. Accordingly, the threat tracker circuitry 106 may track and analyze email attachments for malicious content. The threat tracker circuitry 106 may additionally track the number of times a given sender address is added to threat list 304 so that the threat manager circuitry 108 can impose increased filtering or heightened security measures on frequent visitors. In the example of FIG. 4C, the responsive actions of the threat manager circuitry 108 also include preventing the recipient inbox from receiving or displaying the email.

In the example of FIG. 4D, the data senders 402D and 402E are endpoint devices (e.g., one or more of the server 112A, tablet 112B, laptop 112C, mobile phone 112D, etc. of FIG. 1). Accordingly, the endpoint devices can both consume data and transmit data based on the behavior of consumers that operate the devices. The threat tracker circuitry 106 analyzes behavioral data that characterizes user activity of the endpoint devices 402D, 402E. The threat tracker circuitry 106 may implement such behavior analysis using techniques generally referred to as Endpoint Detection and Response (EDR), which focuses on a specific endpoint device 402D. Additionally or alternatively, the threat tracker circuitry 106 implements such behavior analysis using techniques generally referred to as Extended Detection and Response (XDR), which extends the behavior analysis across a network of endpoint devices 402D, 402E.

Behavioral data transmitted by the endpoint devices 402D, 402E may include but is not limited to file modifications, transmissions to other devices (e.g., the data consumers 404D, 404E), etc. In the example of FIG. 4D, the responsive actions of the threat manager circuitry 108 include preventing the data transmitted by the endpoints 402D, 402E from reaching their respective endpoint destinations 404D, 404E. In some examples, the responsive actions of the threat manager circuitry 108 are additionally or alternatively directed towards the endpoint devices 402D, 402E, which may be acting maliciously (e.g., running malware) without the knowledge of a corresponding user.

In the example of FIG. 4E, the data source 402F refers to one or more unknown devices and the data consumer 404F is a server device. The unknown devices transmit data that represents an API call over a network. If received by the data consumer 404F, the API call prompts the server device to transmit a reply message to one of the unknown devices. Accordingly, the threat tracker circuitry 106 and threat manager circuitry 108 track and respond to patterns of abuse or malicious activity from specific API keys or service accounts. The threat tracker circuitry 106 may also monitor user actions within a cloud service to identify patterns of malicious behavior. Once a device is identified as malicious and put on the threat list 304, the threat manager circuitry 108 limits the amount of operations the server device performs on behalf of the device. Such limited operations include but are not limited to the number of to API responses, the number of executed functions, etc.

While an example manner of implementing the threat tracker circuitry 106 and threat manager circuitry 108 of FIG. 1 is illustrated in FIGS. 2 and 3, one or more of the elements, processes, and/or devices illustrated in FIGS. 2 and 3 may be combined, divided, re-arranged, omitted, eliminated, and/or implemented in any other way. Further, the analysis circuitry 202, the event counter circuitry 206, the threshold circuitry 208, the threat list editor circuitry 302, the threat mitigation circuitry 306, and/or, more generally, the example threat tracker circuitry 106 and threat manager circuitry 108 of FIGS. 2 and 3, may be implemented by hardware alone or by hardware in combination with software and/or firmware. Thus, for example, any of analysis circuitry 202, the event counter circuitry 206, the threshold circuitry 208, the threat list editor circuitry 302, the threat mitigation circuitry 306, and/or, more generally, the example threat tracker circuitry 106 and threat manager circuitry 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example threat tracker circuitry 106 and threat manager circuitry 108 of FIGS. 2 and 3 may include one or more elements, processes, and/or devices in addition to, or instead of, those illustrated in FIGS. 2 and 3, and/or may include more than one of any or all of the illustrated elements, processes and devices.

Flowchart(s) representative of example machine readable instructions, which may be executed by programmable circuitry to implement and/or instantiate the threat tracker circuitry 106 and threat manager circuitry 108 of FIGS. 2 and 3 and/or representative of example operations which may be performed by programmable circuitry to implement and/or instantiate the threat tracker circuitry 106 and threat manager circuitry 108 of FIGS. 2 and 3, are shown in FIGS. 5, 6, and/or 7. The machine readable instructions may be one or more executable programs or portion(s) of one or more executable programs for execution by programmable circuitry such as the programmable circuitry 812 shown in the example programmable circuitry platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5, 6, and/or 7, many other methods of implementing the example threat tracker circuitry 106 and threat manager circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5, 6, and/or 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to implement the threat tracker circuitry 106. The example machine-readable instructions and/or the example operations 500 begin when the analysis circuitry 202 analyzes incoming detection data. (Block 502). The detection data may be transmitted from any type of data source. The detection data may contain any type of information and stored in any package. In some examples, the analysis circuitry 202 analyzes detection data at block 502 based on individual transmissions that are received from the data source. In other examples, the analysis circuitry 202 analyzes multiple data transmissions together at block 502.

The analysis circuitry 202 determines whether a potential threat has been identified in the detection data. (Block 504). The analysis circuitry 202 may use any suitable technique to determine whether to label one or more portions of the detection data as a potential threat. Such techniques include but are not limited to signature based detection, statically reviewing metadata, performing operations with the data in a sandbox environment, etc. as described above in connection with FIG. 2. If the analysis circuitry 202 does not identify a potential threat (Block 504: No), control proceeds to block 518. In some examples, the analysis circuitry 202 also forwards data to the receiver circuitry 110 in response to a determination that the detection data does not identify a potential threat (Block 504: No).

Alternatively, if the analysis circuitry 202 does identify a potential threat (Block 504: Yes), the analysis circuitry 202 adds data indicative of the threat to the security event cache 204. (Block 506). The data added in block 506 includes but is not limited to the source of data transmission and a timestamp that represents when the analysis circuitry 202 received the data. In some examples, the analysis circuitry 202 additionally adds other data to the security event cache 204 as described above in connection with FIG. 2.

The event counter circuitry 206 increments a counter corresponding to the source of the potential threat. (Block 508). In some examples, the event counter circuitry 206 manages one counter value per unique data source stored in the event cache 204. In other examples, the threat tracker circuitry 106 determines or receives information that two data sources are associated with a same entity (e.g., one malicious actor is identified as transmitting malware from two separate IP addresses). In some such examples, the event counter circuitry 206 uses one countervalue to track multiple sources that correspond to the same entity.

The threshold circuitry 208 optionally determines whether the counter value of block 508 exceeds a threshold. (Block 510). The threshold of block 510 is adjustable so that, in some examples, a first threshold corresponding to a first data source has a different value than a second threshold corresponding to a second data source.

The threshold circuitry 208 optionally determines whether the source of block 508 passes one or more entrance conditions. (Block 512). Entrance conditions may include but are not limited to determining whether the difference between timestamps that are stored in the security event cache 204 exceed a threshold, determining whether a data transmission corresponding to the source is missing or has invalid authentication, attestation, or encryption data, etc. as described above in connection with FIG. 2.

The threshold circuitry 208 determines whether to add the data source of block 508 to the threat list 304. (Block 514). The threshold circuitry 208 determines whether to add a given data source to the threat list based on the one or more operations that are performed at blocks 510 and/or 512. The threshold circuitry 208 is configurable so that, in some examples, the specific operations performed at blocks 510 and/or 512 is dependent on which source is being considered for addition to the threat list 304. In some examples, the threshold circuitry 208 uses AND logic, OR logic, or a combination of both AND logic and OR logic as described above to evaluate block 514.

If the threshold circuitry 208 decides to not add the data source to the threat list 304 (Block 514: No), control proceeds to block 518. Alternatively, if threshold circuitry 208 decides to add the data source to the threat list 304 (Block 514: Yes), the threshold circuitry 208 notifies the threat manager circuitry 108 and removes the corresponding data from the security event cache. (Block 516). The event counter circuitry 206 also resets the counter value of block 508 when implementing block 516. Removing data from the security event cache 204 and resetting the counter value ensures that a single instance of a potential threat is not reused at a later point in time as a separate reason to add the source to the threat list 304. In other examples, the threat tracker circuitry 106 waits until the source has been removed from the threat list 304 before removing corresponding data from the security event cache 204 and resetting the corresponding counter value.

After block 516, or if a potential threat was not identified (Block 504: No), or if the source was not added to the threat list (Block 514: No), the analysis circuitry 202 determines whether more detection data has been received. (Block 518). If more detection data has been received (Block 518: Yes), control returns to block 502. If detection data has not been received (Block 518: No), the machine-readable instructions and/or operations 500 end.

FIG. 6 is a flowchart representative of example machine readable instructions and/or example operations that may be executed, instantiated, and/or performed by example programmable circuitry to implement the threat manager circuitry of FIG. 1. In the example of FIG. 6, the machine readable instructions and/or operations 600 begin when the threat list editor circuitry 302 determines whether a notification has been received from the threat tracker circuitry 106. (Block 602). The threat list editor circuitry 302 may receive the notification in any suitable format or communication protocol. In some examples, the threat list editor circuitry 302 receives the notification from an external device via a network.

If the threat list editor circuitry 302 has not received a notification from the threat tracker circuitry 106 (Block 602: No), the threat list editor circuitry 302 waits for a period (Block 604) before control returns to bock 602 and the threat list editor circuitry 302 performs another check for a notification. Alternatively, if the threat list editor circuitry 302 has received a notification, the adds the corresponding source and timestamp to the threat list 304. (Block 606). In some examples, the threat list editor circuitry 302 adds additional data that corresponds to the data source at block 606. Such additional data may include but is not limited to information from the security event cache 204 that corresponds to the data source.

The threat mitigation circuitry 306 performs one or more responsive actions directed towards the data source. (Block 608). The responsive actions of block 608 analyze, limit, and/or or prevent security risks that correspond to the data source of block 606. Such responsive actions may include but are not limited to notifying other internal modules or external modules of the threat, establishing filters to identify future data transmissions from the source, editing one or more portions of the existing data 104 to remove the malicious portion, etc.

The threat mitigation circuitry 306 conditionally removes the source from the threat list 304. (Block 610). In some examples, the threat mitigation circuitry 306 determines which conditions to consider at block 610 based on which source is being evaluated. Accordingly, the threat mitigation circuitry 306 may implement a first instance of block 610 using a different set of operations than those used to implement a second instance of block 610. Block 610 is described further in connection with FIG. 7.

FIG. 7 is a flowchart representative of example machine readable instructions and/or example operations that may be executed, instantiated, and/or performed by example programmable circuitry to conditionally remove a source from a threat list as described in FIG. 6. In particular, the flowchart of FIG. 7 is an example implementation of block 610 of FIG. 6.

Implementation of block 610 may begin when the threat list editor circuitry 302 optionally determines whether a threshold amount of time has passed since the addition of the source to the list. (Block 702). The threat list editor circuitry 302 uses the timestamps stored in the threat list 304 to perform the determination of block 702. In some examples, the threat list editor circuitry 302 implements block 702 by setting the threshold amount of time to a comparatively short period, thereby enabling more aggressive removal of sources from the threat list 304. The aggressive removal of sources from the threat list 304 may counteract false positives and support an aggressive addition of sources to the threat list 304 as described above.

The threat list editor circuitry 302 optionally determines whether the source passes one or more exit conditions. (Block 704). Such exit conditions include but are not limited to determining whether the source has attempted to send payload data while on the threat list 304, whether the threat tracker circuitry 106 has received corrected or previously missing authentication, attestation, or encryption data that corresponds to the source, etc.

The threat list editor circuitry 302 determines whether to remove the source from the threat list. (Block 706). The threat list editor circuitry 302 determines whether to remove a given data source from the threat list 304 based on the one or more operations that are performed at blocks 702 and/or 704. In some examples, the threat list editor circuitry 302 uses AND logic, OR logic, or a combination of both AND logic and OR logic to group the foregoing operations together when determining whether to remove the source from the threat list 304. Thus, in a first example, the threat list editor circuitry 302 removes the source from the threat list 304 if the source has been on the list for a threshold amount AND a first exit condition is passed, in a second example, the threat list editor circuitry 302 removes the source from the threat list 304 if the first exit condition OR a second exit condition pass, etc.

If the threat list editor circuitry 302 decides not to remove the source from the threat list 304 (Block 706: No), the threat list editor circuitry 302 waits for a period (Block 708) before reimplementing the one or more operations of blocks 702 and/or 704. Alternatively, if the threat list editor circuitry 302 decides to remove the source from the threat list 304 (Block 710: Yes), the threat mitigation circuitry 306 stops performing responsive actions directed towards the source. (Block 710). In some examples, stopping the responsive actions enables data transmitted from the source to reach the receiver circuitry 110. The threat list editor circuitry 302 may also delete data that corresponds to the source, or allow data that corresponds to the source to be overwritten, from the memory that implements the threat list 304 at block 710. The machine-readable instructions and/or operations 600 end after block 710.

FIG. 8 is a block diagram of an example programmable circuitry platform 800 structured to execute and/or instantiate the example machine-readable instructions and/or the example operations of FIGS. 5, 6, and/or 7 to implement the implement one or more devices in the environment of FIG. 1. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements one or more of the analysis circuitry 202, the event counter circuitry 206, the threshold circuitry 208, the threat list editor circuitry 302, and the threat mitigation circuitry 306.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In this example, the main memory 814, 816 implements one or more of the security event cache 204 and the threat list 304.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 5, 6, and/or 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5, 6, and/or 7 to effectively instantiate the circuitry of FIG. 2 as logic circuits to perform operations corresponding to those machine readable instructions. In some such examples, the circuitry of FIGS. 2 and 3 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5, 6, and/or 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 5, 6, and/or 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5, 6, and/or 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5, 6, and/or 7. As such, the FPGA circuitry 1000 may be configured and/or structured to effectively instantiate some or all of the operations/functions corresponding to the machine readable instructions of the flowchart(s) of FIGS. 5, 6, and/or 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 5, 6, and/or 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 5, 6, and/or 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 5, 6, and/or 7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 5, 6, and/or 7, and/or an ASIC may be configured and/or structured to perform third operation(s)/function(s) corresponding to a third portion of the machine readable instructions represented by the flowcharts of FIGS. 5, 6, and/or 7.

It should be understood that some or all of the circuitry of FIGS. 2 and 3 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

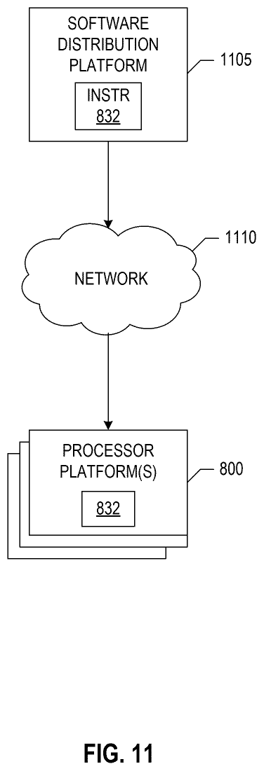

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 5, 6, and/or 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 5, 6, and/or 7, may be downloaded to the example programmable circuitry platform 800, which is to execute the machine readable instructions 832 to implement the threat tracker circuitry 106 and threat manager circuitry 108. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third. ” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement a dynamic threat list. Disclosed systems, apparatus, articles of manufacture, and methods improve the efficiency of using a computing device by: a) add items to a threat list if a threshold number of entries in the security event cache correspond to a single source and/or if the source passes one or more entrance conditions and b) remove items from a threat list after the source has been on the threat list for a threshold amount of time and/or if the source passes one or more exit conditions, where the operations to both add and remove items are performed continuously and in substantially real time. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to dynamically update a threat list are disclosed herein. Further examples and combinations thereof include the following.

Example 1 includes an apparatus to update a threat list, the apparatus comprising interface circuitry, machine readable instructions, and programmable circuitry to at least one of instantiate or execute the machine readable instructions to analyze detection data from an unknown source to identify a potential threat, add an entry to a security event cache that describes the potential threat, determine a number of entries in the security event cache that correspond to the unknown source, in response to a determination that the number of entries exceeds a threshold, add the unknown source to a threat list, and perform, in response to the addition of the unknown source to the threat list, a responsive action corresponding to the unknown source.

Example 2 includes the apparatus of example 1, wherein the programmable circuitry is to remove, in response to the addition of the unknown source to the threat list, entries that correspond to the unknown source from the security event cache.

Example 3 includes the apparatus of example 1, wherein the programmable circuitry is to remove the unknown source from the threat list after a threshold amount of time passes since the addition of the unknown source to the threat list.

Example 4 includes the apparatus of example 1, wherein the programmable circuitry is to add the entry to the security event cache in response to a determination that the potential threat passes a logical condition.

Example 5 includes the apparatus of example 4, wherein the potential threat is a second potential threat, the second potential threat is identified at a second time stamp, and the programmable circuitry is to identify a first potential threat from the unknown source at a first time stamp, the first time stamp chronologically earlier than the second time stamp, and determine the second potential threat passes the logical condition in response to a determination that a difference between the second time stamp and the first time stamp is less than a threshold value.

Example 6 includes the apparatus of example 4, wherein the programmable circuitry is to determine the potential threat passes the logical condition in response to a determination that the detection data corresponding to the potential threat includes invalid authentication, attestation, or encryption data.

Example 7 includes the apparatus of example 1, wherein the programmable circuitry is to identify the detection data at a first time stamp, and perform the responsive action in substantially real time after the first time stamp.

Example 8 includes the apparatus of example 1, wherein the detection data includes an internet protocol (IP) address of the unknown source, and to perform the responsive action, the programmable circuitry is to prevent an Internet browser from accessing a webpage hosted by the unknown source.

Example 9 includes the apparatus of example 1, wherein the unknown source is a software application, the detection data corresponds to application files produced by software application, and to perform the responsive action, the programmable circuitry is to prevent communication between the software application and an operating system.

Example 10 includes the apparatus of example 1, wherein the detection data corresponds to an email message, and to perform the responsive action, the programmable circuitry is to prevent a recipient device from receiving the email message.

Example 11 includes the apparatus of example 1, wherein the detection data corresponds to one or more device events or files, and the programmable circuitry is to identify the potential threat by performing behavioral analysis on the one or more device events or files, and perform the responsive action by performing Endpoint Detection and Response (EDR) operations.

Example 12 includes the apparatus of example 1, wherein the detection data corresponds to an Application Program Interface (API) call, and to perform the responsive action, the programmable circuitry is to prevent a server device from responding to the API call.

Example 13 includes a non-transitory machine readable storage medium comprising instructions to cause programmable circuitry to at least analyze detection data from an unknown source to identify a potential threat, add an entry to a security event cache that describes the potential threat, determine a number of entries in the security event cache that correspond to the unknown source, in response to a determination that the number of entries exceeds a threshold, add the unknown source to a threat list, and perform, in response to the addition of the unknown source to the threat list, a responsive action corresponding to the unknown source.

Example 14 includes the non-transitory machine readable storage medium of example 13, wherein the programmable circuitry is to remove, in response to the addition of the unknown source to the threat list, entries that correspond to the unknown source from the security event cache.

Example 15 includes the non-transitory machine readable storage medium of example 13, wherein the programmable circuitry is to remove the unknown source from the threat list after a threshold amount of time passes since the addition of the unknown source to the threat list.

Example 16 includes the non-transitory machine readable storage medium of example 13, wherein the programmable circuitry is to add the entry to the security event cache in response to a determination that the potential threat passes a logical condition.

Example 17 includes the non-transitory machine readable storage medium of example 16, wherein the potential threat is a second potential threat, the second potential threat is identified at a second time stamp, and the programmable circuitry is to identify a first potential threat from the unknown source at a first time stamp, the first time stamp chronologically earlier than the second time stamp, and determine the second potential threat passes the logical condition in response to a determination that a difference between the second time stamp and the first time stamp is less than a threshold value.

Example 18 includes the non-transitory machine readable storage medium of example 16, wherein the programmable circuitry is to determine the potential threat passes the logical condition in response to a determination that the detection data corresponding to the potential threat includes invalid authentication, attestation, or encryption data.

Example 19 includes the non-transitory machine readable storage medium of example 13, wherein the programmable circuitry is to identify the detection data at a first time stamp, and perform the responsive action in substantially real time after the first time stamp.

Example 20 includes the non-transitory machine readable storage medium of example 13, wherein the detection data includes an internet protocol (IP) address of the unknown source, and to perform the responsive action, the programmable circuitry is to prevent an Internet browser from accessing a webpage hosted by the unknown source.

Example 21 includes the non-transitory machine readable storage medium of example 13, wherein the unknown source is a software application, the detection data corresponds to application files produced by software application, and to perform the responsive action, the programmable circuitry is to prevent communication between the software application and an operating system.

Example 22 includes the non-transitory machine readable storage medium of example 13, wherein the detection data corresponds to an email message, and to perform the responsive action, the programmable circuitry is to prevent a recipient device from receiving the email message.

Example 23 includes the non-transitory machine readable storage medium of example 13, wherein the detection data corresponds to one or more device events or files, and the programmable circuitry is to identify the potential threat by performing behavioral analysis on the one or more device events or files, and perform the responsive action by performing Endpoint Detection and Response (EDR) operations.

Example 24 includes the non-transitory machine readable storage medium of example 13, wherein the detection data corresponds to an Application Program Interface (API) call, and to perform the responsive action, the programmable circuitry is to prevent a server device from responding to the API call.

Example 25 includes a method to update a threat list, the method comprising analyzing detection data from an unknown source to identify a potential threat, adding an entry to a security event cache that describes the potential threat, determining a number of entries in the security event cache that correspond to the unknown source, in response to a determination that the number of entries exceeds a threshold, adding the unknown source to a threat list, and performing, in response to the addition of the unknown source to the threat list, a responsive action corresponding to the unknown source.

Example 26 includes the method of example 25, further including removing, in response to the addition of the unknown source to the threat list, entries that correspond to the unknown source from the security event cache.

Example 27 includes the method of example 25, further including removing the unknown source from the threat list after a threshold amount of time passes since the addition of the unknown source to the threat list.

Example 28 includes the method of example 25, further including adding the entry to the security event cache in response to a determination that the potential threat passes a logical condition.

Example 29 includes the method of example 28, wherein the potential threat is a second potential threat, the second potential threat is identified at a second time stamp, the method further includes identifying a first potential threat from the unknown source at a first time stamp, the first time stamp chronologically earlier than the second time stamp, and determining the second potential threat passes the logical condition in response to a determination that a difference between the second time stamp and the first time stamp is less than a threshold value.

Example 30 includes the method of example 28, further including determining the potential threat passes the logical condition in response to a determination that the detection data corresponding to the potential threat includes invalid authentication, attestation, or encryption data.

Example 31 includes the method of example 25, further including identifying the detection data at a first time stamp, and performing the responsive action in substantially real time after the first time stamp.

Example 32 includes the method of example 25, wherein the detection data includes an internet protocol (IP) address of the unknown source, and performing the responsive action further includes preventing an Internet browser from accessing a webpage hosted by the unknown source.

Example 33 includes the method of example 25, wherein the unknown source is a software application, the detection data corresponds to application files produced by software application, and performing the responsive action further includes preventing communication between the software application and an operating system.

Example 34 includes the method of example 25, wherein the detection data corresponds to an email message, and performing the responsive action further includes preventing a recipient device from receiving the email message.

Example 35 includes the method of example 25, wherein the detection data corresponds to one or more device events or files, and the method further includes identifying the potential threat by performing behavioral analysis on the one or more device events or files, and performing the responsive action by performing Endpoint Detection and Response (EDR) operations.

Example 36 includes the method of example 25, wherein the detection data corresponds to an Application Program Interface (API) call, and performing the responsive action further includes preventing a server device from responding to the API call.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to update a threat list, the apparatus comprising:
interface circuitry;
machine readable instructions; and
programmable circuitry to at least one of instantiate or execute the machine readable instructions to:
analyze detection data from an unknown source to identify a potential threat;
add an entry to a security event cache that describes the potential threat;
determine a number of entries in the security event cache that correspond to the unknown source;
in response to a determination that the number of entries exceeds a threshold, add the unknown source to a threat list; and
perform, in response to the addition of the unknown source to the threat list, a responsive action corresponding to the unknown source.

2. The apparatus of claim 1, wherein the programmable circuitry is to remove, in response to the addition of the unknown source to the threat list, entries that correspond to the unknown source from the security event cache.

3. The apparatus of claim 1, wherein the programmable circuitry is to remove the unknown source from the threat list after a threshold amount of time passes since the addition of the unknown source to the threat list.

4. The apparatus of claim 1, wherein the programmable circuitry is to add the entry to the security event cache in response to a determination that the potential threat passes a logical condition.

5. The apparatus of claim 4, wherein:
the potential threat is a second potential threat, the second potential threat is identified at a second time stamp; and
the programmable circuitry is to:
identify a first potential threat from the unknown source at a first time stamp, the first time stamp chronologically earlier than the second time stamp; and
determine the second potential threat passes the logical condition in response to a determination that a difference between the second time stamp and the first time stamp is less than a threshold value.

6. The apparatus of claim 4, wherein the programmable circuitry is to determine the potential threat passes the logical condition in response to a determination that the detection data corresponding to the potential threat includes invalid authentication, attestation, or encryption data.

7. The apparatus of claim 1, wherein the programmable circuitry is to:
identify the detection data at a first time stamp; and
perform the responsive action in substantially real time after the first time stamp.

8. The apparatus of claim 1, wherein:
the detection data includes an internet protocol (IP) address of the unknown source; and
to perform the responsive action, the programmable circuitry is to prevent an Internet browser from accessing a webpage hosted by the unknown source.

9. The apparatus of claim 1, wherein:
the unknown source is a software application;
the detection data corresponds to application files produced by software application; and
to perform the responsive action, the programmable circuitry is to prevent communication between the software application and an operating system.

10. The apparatus of claim 1, wherein the detection data corresponds to an email message, and to perform the responsive action, the programmable circuitry is to prevent a recipient device from receiving the email message.

11. The apparatus of claim 1, wherein the detection data corresponds to one or more device events or files, and the programmable circuitry is to:
identify the potential threat by performing behavioral analysis on the one or more device events or files; and
perform the responsive action by performing Endpoint Detection and Response (EDR) operations.

12. The apparatus of claim 1, wherein:
the detection data corresponds to an Application Program Interface (API) call; and
to perform the responsive action, the programmable circuitry is to prevent a server device from responding to the API call.

13. A non-transitory machine readable storage medium comprising instructions to cause programmable circuitry to at least:
analyze detection data from an unknown source to identify a potential threat;
add an entry to a security event cache that describes the potential threat;
determine a number of entries in the security event cache that correspond to the unknown source;
in response to a determination that the number of entries exceeds a threshold, add the unknown source to a threat list; and
perform, in response to the addition of the unknown source to the threat list, a responsive action corresponding to the unknown source.

14. The non-transitory machine readable storage medium of claim 13, wherein the programmable circuitry is to remove, in response to the addition of the unknown source to the threat list, entries that correspond to the unknown source from the security event cache.

15. The non-transitory machine readable storage medium of claim 13, wherein the programmable circuitry is to remove the unknown source from the threat list after a threshold amount of time passes since the addition of the unknown source to the threat list.

16. The non-transitory machine readable storage medium of claim 13, wherein the programmable circuitry is to add the entry to the security event cache in response to a determination that the potential threat passes a logical condition.

17. The non-transitory machine readable storage medium of claim 16, wherein:
the potential threat is a second potential threat, the second potential threat is identified at a second time stamp; and
the programmable circuitry is to:
identify a first potential threat from the unknown source at a first time stamp, the first time stamp chronologically earlier than the second time stamp; and
determine the second potential threat passes the logical condition in response to a determination that a difference between the second time stamp and the first time stamp is less than a threshold value.

18. The non-transitory machine readable storage medium of claim 16, wherein the programmable circuitry is to determine the potential threat passes the logical condition in response to a determination that the detection data corresponding to the potential threat includes invalid authentication, attestation, or encryption data.

19. A method to update a threat list, the method comprising:
analyzing detection data from an unknown source to identify a potential threat;
adding an entry to a security event cache that describes the potential threat;
determining a number of entries in the security event cache that correspond to the unknown source;
in response to a determination that the number of entries exceeds a threshold, adding the unknown source to a threat list; and
performing, in response to the addition of the unknown source to the threat list, a responsive action corresponding to the unknown source.

20. The method of claim 19, further including removing, in response to the addition of the unknown source to the threat list, entries that correspond to the unknown source from the security event cache.
